(19) United States
(12) Patent Application Publication
(10) Pub. No.: US 2015/0079262 A1
(43) Pub. Date: Mar. 19, 2015

(54) COMPOSITION

(71) Applicant: BRITVIC SOFT DRINKS LIMITED, Hemel Hempstead (GB)

(72) Inventor: Philip Spratt, Hemel Hempstead (GB)

(73) Assignee: BRITVIC SOFT DRINKS LIMITED, Hemel Hempstead (GB)

(21) Appl. No.: 14/391,606

(22) PCT Filed: Apr. 10, 2013
(86) PCT No.: PCT/GB2013/050924

§ 371 Date: Oct. 9, 2014

(30) Foreign Application Priority Data
Apr. 12, 2012 (GB) 1206457.2

(51) Int. Cl. A23L 2/02; A23L 2/52; A23L 2/56; A23L 2/60; A23L 2/58

(52) U.S. Cl. CPC A23L 2/02; A23L 2/60; A23L 2/58; A23L 2/56; A23L 2/52; A23V 2002/00
USPC 426/548; 426/599

(57) ABSTRACT

The invention provides a fruit juice composition wherein dilution of one volume of the fruit juice composition with about 35 to about 200 volumes of liquid provides a beverage comprising about 0.2% to about 10% fruit juice. The invention further provides a packaged fruit juice composition and a method of making a beverage.

The present invention relates to fruit juice compositions suitable for dilution to provide fruit juice containing beverages.

Beverages comprising fruit juice may be provided as concentrates that may be diluted by the consumer before drinking the beverage.

These concentrates are often provided as a liquid which is intended to be diluted with about one part concentrate and 4 to 10 parts water to provide a palatable beverage. The concentrates also may comprise added sugar, such as sucrose or glucose, or artificial sweeteners, usually saccharin or aspartame.

Consumers enjoy beverages that comprise real fruit juice because they like the taste and because they are more natural and healthy than fruit flavoured beverages that do not comprise fruit.

It would be advantageous to provide a liquid fruit juice composition, containing real fruit juice, that is more concentrated than those fruit juice concentrates currently for sale because it would allow a smaller amount of the composition to be used to make a palatable beverage. A more concentrated fruit juice composition could also be sold in smaller bottles or package sizes which are lighter and easier to transport, saving transportation costs and also storage space in warehouses and supermarkets. Smaller bottles or package sizes would also provide advantages for the consumer because they are easier to take home and store after purchase, and they are also more portable so that the consumer can easily carry them around, and they also create less waste.

The problem with providing concentrated fruit juice compositions is that additional sweetness may be required, in addition to the natural sugars in the fruit, in order to provide the flavour and level of sweetness desired by consumers. At high concentrations not enough sugar can be dissolved in a liquid concentrate to provide the appropriate sweetness when the concentrate is diluted. Without added sugar/sweetener drinks comprising natural fruit juices may be unpalatable to consumers.

The present invention provides a concentrated fruit juice composition that can be diluted with about 35 to about 200 volumes of liquid to provide a palatable beverage comprising about 0.2% to about 10% fruit juice.

Accordingly, in a first aspect the present invention provides a fruit juice composition wherein dilution of one volume of the fruit juice composition with about 35 to about 200 volumes of liquid provides a beverage comprising between about 0.2% and about 10% fruit juice. In this embodiment one volume of fruit juice composition may be added to about 35 to about 200 volumes of a liquid that does not comprise fruit juice to provide a beverage comprising between about 0.2% and about 10% fruit juice.

Preferably when a composition of the invention is diluted one volume of the composition with about 35 to about 200 volumes of a liquid that does not comprise fruit juice the resulting beverage comprises between about 0.3% and about 10% fruit juice, between about 0.4% and about 10% fruit juice, between about 0.5% and about 10% fruit juice, between about 0.6% and about 10% fruit juice, between about 0.7% and about 10% fruit juice, between about 0.8% and about 10% fruit juice, between about 0.9% and about 10% fruit juice, between about 1% and about 10% fruit juice, between about 2% and about 10% fruit juice. Preferably between about 0.5% and about 10% fruit juice.

As used herein a fruit juice composition is a composition that comprises fruit juice but also has at least one other ingredient, for example, one or more of water, sugar, artificial sweetener, high intensity sweetener, colouring, flavouring, citric acid, ascorbic acid, malic acid, phosphoric acid, acidity regulator, preservative, vitamin, mineral, thickener, flavour enhancer and/or other ingredient common in the food and beverage industry.

As used herein fruit juice preferably means material derived wholly from fruits. Fruit juice may comprise juice, fruit pulp and/or fruit comminute wholly derived from fruit.

100% fruit juice is fruit juice, pulp and/or comminute that is 100% derived from fruit and has not been concentrated or diluted. Fruit juice compositions comprising in effect more than 100% fruit juice may be made by concentrating the fruit juice, for example by removing naturally occurring water. Fruit juice compositions comprising less than 100% fruit juice may be made by diluting the fruit juice composition, for example with water or another liquid.

In one embodiment, a fruit juice composition of the invention comprises fruit comminute. Preferably, the comminute in the fruit juice composition has been concentrated.

The fruit juice of the present invention may be derived from any suitable fruit, for example, orange, lemon, lime, grapefruit, blackcurrant, apple, blackberry, red currant, pineapple, peach, mango, pomegranate, cranberry, grape, strawberry, raspberry, plum, pear and/or tomato.

As used herein a beverage is a composition comprising a fruit juice composition and other diluting ingredients to make it suitable for or intended for consumption by a consumer. For example, a beverage may be a quantity of a fruit juice composition diluted with a suitable liquid, for example, water.

A beverage may be made by diluting a fruit juice composition with a suitable quantity of a liquid that does not comprise fruit juice, for example, still water, sparkling water, soda water, tonic water, milk and/or tea. A beverage may be made by diluting a fruit juice composition with a suitable quantity of a liquid that comprises fruit juice but this may provide a beverage with a different percentage fruit juice than would be expected if the same quantity of fruit juice composition was diluted with a liquid that does not comprise fruit juice.

It is advantageous to provide a beverage comprising between about 0.2% and about 10% fruit juice because these beverages may be palatable to the consumer and may be healthy and/or natural because they comprise fruit juice. Preferably the beverage comprises between about 0.5% and about 10% fruit juice.

It is advantageous to provide a fruit juice composition wherein one volume of the fruit juice composition may be diluted with about 35 to about 200 volumes of liquid because only a small volume of fruit juice composition may be required to provide a fruit juice containing beverage.

A fruit juice composition of the present invention may be described as a super-concentrated fruit juice composition because it may be diluted with a large amount of liquid to provide a beverage with the desired amount of fruit juice.

In the present invention, knowing the percentage of fruit juice in a given volume of the fruit juice composition allows the user to calculate the amount of fruit juice in a beverage made by diluting the composition if the amount of additional liquid that is added to the fruit juice composition is known.

In one embodiment one volume of fruit juice composition may be diluted with about 35 to about 200 volumes, about 35 to about 100, preferably, about 35 to about 90 volumes, preferably about 35 to about 80 volumes, preferably about 50 to about 80 volumes of a liquid that does not comprise fruit juice to provide a beverage that comprises between about 0.2% and about 10% fruit juice, preferably between about 0.5% and about 10%, preferably about 0.2%, about 5%, about 1%, about 2%, about 3%, about 4% or about 5% or more fruit juice. Preferably one volume of fruit juice composition is intended to be diluted with about 35 volumes or more, about 40 volumes or more, about 50 volumes or more, about 55 volumes or more, about 60 volumes or more, about 65 volumes or more, about 70 volumes or more, about 75 volumes or more, about 80 volumes or more, about 85 volumes or more, about 90 volumes or more of diluent, such as still or sparkling water.

In one embodiment the addition of about one volume of a fruit juice composition according to the invention to about 35 to about 200 volumes of another non-fruit containing liquid provides a beverage comprising between about 0.2% and about 10% fruit juice, preferably between about 0.5 to about 10%, for example about 0.5%, about 1%, about 2%, about 3%, about 4%, about 5% or more fruit juice. In another embodiment the addition of about one volume of a fruit juice composition according to the invention to about 60 to 80 volumes of a non-fruit containing liquid provides a beverage comprising between about 0.2% and about 2% fruit juice.

The fruit juice composition may comprises between about 40% and about 200% fruit juice equivalent, or between about 50% and about 200% fruit juice equivalent, or between about 70% and about 200% fruit juice equivalent, or between about 70% and about 180% fruit juice equivalent, or between about 50% and about 180% fruit juice equivalent, or between about 40% and about 180% fruit juice equivalent, or between about 40% and about 150% fruit juice equivalent, or between about 50% and about 150% fruit juice equivalent, or between about 40% and about 130% fruit juice equivalent, or between about 50% and about 130% fruit juice equivalent, or between about 50% and about 120% fruit juice equivalent, or between about 40% and about 120% fruit juice equivalent, or between about 50% and about 100% fruit juice equivalent, or between about 40% and about 100% fruit juice equivalent, or between about 70% and about 150% fruit juice equivalent, or between about 70% and about 120% fruit juice equivalent, or between about 70% and about 100% fruit juice equivalent. Fruit juice equivalent is intended to refer to the effective amount of fruit juice in a composition bearing in mind that a concentrated fruit juice could be used to make the fruit juice composition. For example if a fruit juice, such as a fruit comminute, is two times concentrated, and then used to produce a fruit juice composition which comprises 50% by volume of two times concentrate comminute, then the fruit juice composition will contain 100% fruit juice equivalent.

Preferably the fruit juice composition comprises at least about 40%, 50%, 60%, 70%, 80%, 90%, 100%, 110%, 120%, 130%, 140%, 150%, 160%, 170%, 180% fruit juice or fruit juice equivalent.

The fruit juice composition may comprise fruit juice from more than one type of fruit. This is advantageous because it provides a larger range of flavours of fruit juice beverages than is available from compositions comprising a single type of fruit juice.

The fruit juice composition may comprise one or more artificial sweeteners and/or high intensity sweeteners.. This is advantageous because the same sweetness may be provided with less sugar. This is also advantageous because, for very concentrated fruit juice compositions, it is difficult to dissolve enough sugar in the composition to give the required sweetness when the composition is diluted to make a beverage.

The fruit juice composition may comprise acesulfame K and/or sucralose. This is advantageous because fruit juice compositions may be acidic, and the inventors have found that acesulfame K and sucralose are acid stable sweeteners which are stable in fruit juice compositions of the invention. Acesulfame K and sucralose provide both the advantage of providing sweetness to the fruit juice composition and being stable in acid conditions in the fruit juice composition.

In a fruit juice composition comprising a high intensity sweetener the high intensity sweetener may be neotame, cyclamate, alitame, steviside/stevia, sucralose and/or acesulfame K. The high intensity sweeteners in a fruit juice composition may be sucralose and/or acesulfame K. A fruit juice composition may in one embodiment not comprise any other high intensity sweeteners except sucralose and/or acesulfame K.

The fruit juice composition may comprise about 3 g to about 50 g per litre, preferably about 3 g to about 30 g per litre, preferably about 5 g to about 20 g per litre, of high intensity sweetener, such as sucralose or acesulfame K. The fruit juice composition may also, or alternatively, comprise about 3 g to about 50 g per litre acesulfame K. In one embodiment a fruit juice composition may comprise about 3 g to about 50 g per litre of a combination of acesulfame K and sucralose.

The fruit juice composition may have a pH of about 1.5 to about 3, preferably between about 1.9 and 2.6, more preferably between about 2 and 2.5.

The fruit juice composition may comprise no added sugar. The fruit juice composition may comprise sugar derived from the fruit juice and no additional sugar. This is advantageous because many consumers wish to reduce the amount of sugar they consume and drinking beverages that do not comprise added sugar can be helpful in reducing the amount of sugar consumed.

In one embodiment a fruit juice composition may further comprise one or more components selected from: natural or artificial colouring, acidity regulator, flavourings, preservatives, citric acid, acidity regulators and water.

Preservatives may include sorbates, benzoates and sulphur dioxide. Acidulants may include tartaric acid, phosphoric acid, lactic acid, acetic acid, fumaric acid and ascorbic acid.

Preferably the fruit juice composition comprises no artificial colours.

The fruit juice composition may comprise anthrocyanin from black carrot. It is advantageous to use anthrocyanin, preferably from black carrot, as a colour in fruit juice compositions because it is acid stable. Fruit juice compositions comprising a high fruit juice content may be acidic.

In an embodiment, if the fruit juice composition comprises flavours and/or colours then only natural colours and/or natural flavours are used.

The fruit juice composition may have a shelf life at room temperature of at least 3 months, 6 months, 9 months, 12 months or more.

The fruit juice composition may comprise no, or significantly no alcohol. The fruit juice composition may comprise less than about 5%, less than about 4%, less than about 3%, less than about 2%, less than about 1.5%, less than about 1.4%, less than about 1.3, less than about 1.2%, less than about 1.1%, less than about 1%, less than about 0.9%, less than about 0.8%, less than about 0.7%, less than about 0.6%, less than about 0.5% by weight or volume of alcohol.

In one embodiment a beverage may be prepared by diluting the fruit juice composition described above with a potable liquid.

In one embodiment a beverage may comprise about 0.2% to about 10% fruit juice, preferably about 0.5% to about 10% fruit juice, preferably about 0.2%, 0.5%, 1%, 2%, 3%, 4%, 5% or more fruit juice.

In one embodiment a fruit juice composition may be packaged in a container comprising about 5 ml to about 1000 ml fruit juice composition. In one embodiment a fruit juice composition may be packaged in a dosing bottle capable of providing a dose comprising a suitable quantity of fruit juice composition for one serving of fruit juice beverage.

In another aspect the present invention may provide a method of making a beverage comprising the step of admixing a fruit juice composition according to the present invention with a potable liquid.

The method may comprise admixing a fruit juice composition according to the present invention with an edible/potable liquid that does not comprise fruit juice and the beverage may comprise about 0.2% to about 10% fruit juice, preferably about 0.5% to about 10% fruit juice.

The method may comprise admixing a fruit juice composition according to the present invention with an edible/potable liquid that does comprise fruit and the beverage may comprise more than about 0.5% to more than about 10% fruit juice.

In another aspect the present invention provides a beverage comprising a fruit juice composition according to the present invention or a beverage provided by a method of making a beverage according to the present invention.

The beverage may be chilled below ambient temperature before consumption. The beverage may be heated above ambient temperature before consumption.

In another aspect, the present invention provides a packaged fruit juice composition comprising a container and a fruit juice composition according to the invention within the container. The packaged fruit juice composition may comprise a single serving of fruit juice composition. The packaged fruit juice composition may comprise more than one serving of fruit juice composition. The packaged fruit juice composition may comprise a dosing measure to aid the measurement of a serving of fruit juice composition. The packaged fruit juice composition may comprise more than one serving of fruit juice composition in a dosing packaging capable of being actuated to provide a suitable quantity of fruit juice composition for a single serving.

In another embodiment the present invention provides a method of making a fruit juice composition comprising the steps of mixing a fruit comminute or concentrated fruit juice, with water and one or more sweeteners to produce a composition comprising between about 40% and about 200% fruit juice, or between about 50% and about 200% fruit juice, or between about 70% and about 200% fruit juice, or between about 70% and about 180% fruit juice. The method may further comprise the step admixing further ingredients selected from: sugar, colouring, flavour, preservative, acidity regulator, citric acid and/or other ingredients in the fruit juice composition.

The fruit comminute may or may not have been concentrated before use, the fruit comminute may be concentrated by removing naturally occurring water.

The skilled man will appreciate that preferred features of any one embodiment and/or aspect of the invention may be applied to all other embodiments and/or aspects of the invention.

The present invention will be further described in more detail, by way of example only, with reference to the following figures in which:

### EXAMPLES

Concentrated Fruit Juice Composition for 1+50 Dilution

Dilution of 1 volume of the fruit juice composition below with base plus 50 volumes of water makes an orange juice drink containing 5% orange juice.

| Ingredient | Amount per 1itre concentrate product | |
|---|---|---|
| 4X concentrated Orange | 625 | ml |
| comminute * | | |
| Citric acid anhydrous | 120 | g |
| Sucralose | 5 | g |
| potassium sorbate | 1 | g |

| | |
|---|---|
| RO Water | To 1 litre |

* The comminute consists of pulverised whole orange, with a lot of the water removed. In this case the comminute has been concentrated 4 fold and the equivalent of 245% orange juice is included in the fruit juice composition.

Concentrated Apple and Blackcurrant Fruit Juice Composition for 1+35 Dilution Dilution of 1 volume of the fruit juice composition below with 35 volumes of water makes an apple and blackcurrant juice drink containing 10% fruit juice.

| Ingredient | Amount per 1 litre concentrate product | |
|---|---|---|
| 7X concentrated Apple and | 514 | ml |
| Blackcurrant Juice ** | | |
| Citric acid anhydrous | 100 | g |
| Sucralose | 10 | g |
| Potassium sorbate | 1 | g |
| Acesulfame K+ | 10 | g |
| Anthrocyanin liquid black carrot | 19 | g |
| colour | | |

| | |
|---|---|
| RO Water | To 1 litre |

** These are juices that have been concentrated up by the removal of much of the water by evaporation to produce a 7X concentrated product. In the fruit juice composition, before dilution, there is the equivalent of 350% juice.

Anthrocyanin from black carrot is used as it is more acid.

Concentrated Summer Fruits Fruit Juice Composition for 1+200 Dilution

Dilution of 1 volume of this concentrated summer fruits fruit juice composition with 200 volumes of water makes a summer fruits juice drink containing 1% fruit juice.

| Ingredient | Amount per 1 litre concentrate product | |
|---|---|---|
| 6.5X concentrated Summer | 309 | ml |
| Fruits Juice *** | | |
| Citric acid anhydrous | 45.50. | g |
| Sucralose+ | 7.8 | g |
| Acesulfame K++ | 10 | g |
| Preservative | 0.26 | g |
| Anthrocyanin liquid black | 7.5 | ml |
| carrot colour | | |

| | |
|---|---|
| RO Water | To 1 litre |

*** These are juices that have been concentrated up by the removal of much of the water such that the concentrate is 6.5X concentrated. In this fruit juice composition there is the equivalent of 200% fruit juice from concentrate.

Anthrocyanin from black carrot is used as it is more acid stable.

Concentrated Fruit Juice Composition for 1+50 Dilution Dilution of 1 volume of the fruit juice composition below with base plus 50 volumes of water makes an orange juice drink containing 0.5% orange juice.

| Ingredient | Amount per 1itre concentrate product | |
|---|---|---|
| 4X concentrated Orange | 62.5 | ml |
| comminute * | | |
| Citric acid anhydrous | 12 | g |
| Sucralose | 0.5 | g |
| potassium sorbate | 0.1 | g |

| | |
|---|---|
| RO Water | To 1 litre |

Concentrated Fruit Juice Composition for 1+50 Dilution

Dilution of 1 volume of the fruit juice composition below with base plus 50 volumes of water makes an orange juice drink containing 0.5% orange juice.

| Ingredient | Amount per 1itre concentrate product | |
|---|---|---|
| 4X concentrated Orange | 62.5 | ml |
| comminute * | | |
| Citric acid anhydrous | 120 | g |
| Sucralose | 5 | g |
| potassium sorbate | 1 | g |

| | |
|---|---|
| RO Water | To 1 litre |

1. A fruit juice composition wherein dilution of one volume of the fruit juice composition with about 35 to about 200 volumes of liquid provides a beverage comprising about 0.2% to about 10% fruit juice.

2-17. (canceled)

18. The fruit juice composition of claim 1 wherein the fruit juice composition comprises between about 40% and about 200% fruit juice equivalent.

19. The fruit juice composition of claim 1 wherein the fruit juice composition further comprises one or more high intensity sweeteners.

20. The fruit juice composition of claim 19 wherein the fruit juice composition comprises acesulfame K and/or sucralose.

21. The fruit juice composition of claim 20 wherein the only high intensity sweeteners in the fruit juice composition are sucralose and/or acesulfame K.

22. The fruit juice composition of claim 20 wherein the fruit juice composition comprises 3 g to 50 g per litre sucralose and/or 3 g to 50 g/litre acesulfame K.

23. The fruit juice composition of claim 1 comprising no added sugar.

24. The fruit juice composition of claim 1 wherein the fruit juice composition further comprises one or more components selected from: colouring agents, acidity regulators, flavourings, preservatives and water.

25. The fruit juice composition of claim 1 comprising less than 5% alcohol.

26. The fruit juice composition of claim 1 comprising less than 1.2% alcohol.

27. The fruit juice composition of claim 1 comprising less than 0.5% alcohol.

28. The fruit juice composition of claim 1 with a pH of between 1.5 and 3.

29. The fruit juice composition of claim 1 made using fruit communite

30. A beverage prepared by diluting the fruit juice composition of claim 1.

31. The beverage of claim 30 comprising about 0.2% to about 10% fruit juice.

32. A packaged fruit juice composition comprising packaging containing a fruit juice composition wherein the fruit juice composition is a fruit juice composition of claim 1.

33. A method of making a beverage comprising the step of admixing a fruit juice composition of claim 1 with a potable liquid.
